(19) United States
(12) Patent Application Publication
(10) Pub. No.: US 2004/0068425 A1
(43) Pub. Date: Apr. 8, 2004

(54) Computer-network-aided quotation analysis system and method thereof

(76) Inventor: Jonathan C. Shih, Sarotoga, CA (US)

Correspondence Address: BIRCH STEWART KOLASCH & BIRCH, PO BOX 747, FALLS CHURCH, VA, 22040-0747, US

(21) Appl. No.: 10/456,753

(22) Filed: Jun. 9, 2003

(30) Foreign Application Priority Data
Oct. 8, 2002 (TW) 91123160

(51) Int. Cl. G06F 17/60

(52) U.S. Cl. 705/7

(57) ABSTRACT

A computer-network-aided quotation analysis system and method are provided for executing the standard or customized quotation processes by the quotation requirements of the user, built-in quotation rules and the dynamic prices of items with the aid of computer networks. It also builds a learning and analysis mechanism for all quotation results to improve quotation efficiency and competitiveness.

### BACKGROUND OF THE INVENTION

1. Field of the Invention

This invention is related to an automatic quotation analysis system, especially to a system and method applied in the quotation processes of EMS (Electronics Manufacturing Services). The invention dynamically quotes and analyzes the quotation requirements put in by the user with the aid of computer networks.

2. Related Art

Quotation is a very complicated problem that is hard to resolve effectively in the area of EMS. Due to the various quotation requirements of customers and high complexity of EMS working model, manufacturers spend much manpower and time on processing various quotations of different customers, hence the efficiency of the quotation processes is low. On the contrary, manufacturers can easily earn more business opportunities if they have an efficient quotation mechanism to provide the customers with the required quotation results immediately. As a result, an efficient quotation mechanism is crucial for EMS manufacturers and is necessary in the area of EMS.

In the past, when requiring quotation, the customer sent the requirements in the form of RFQ (Request For Quotation) to EMS manufacturers by fax or mail, and the manufacturers then quoted according to the RFQ requirements. Therefore, it usually took several working days or longer for each quotation process, which was neither timely nor accurate. Furthermore, the fact that manufacturers did not have a robust management mechanism resulted in repeated processes for the same quotation requirements of different customers, which has serious impact on the efficiency of EMS manufacturer's quotation process.

Nowadays, many EMS manufacturers use computer systems to support quotation processes. Although the efficiency of quotation processes has been improved, uniform quotations taken by the computer systems still cannot satisfy various quotation requirements of different customers and may even reduce the degree of customer satisfaction. This is because of the lack of flexibility and the learning mechanism in the design of computer systems. From the manufacturers' point of view, quotation results simply cannot help them on the analysis, evaluation and improvement of quotation processes. The computerized quotation processes still cannot improve the competitiveness of manufacturers, which is a crucial problem that all EMS manufacturers want to resolve as soon as possible.

How to use the computer-network-related software and hardware effectively, to build a mechanism with learning flexibility and the abilities of evaluation and analysis, to satisfy the customers' needs in quotation requirements timely and conveniently, and to build a quotation analysis system and method to help EMS manufacturers earn more business opportunities, should be the important direction of effort from those EMS manufacturers with urgent desire to increase their competitiveness.

### SUMMARY OF THE INVENTION

This invention proposes a computer-network-aided quotation analysis system and method whose primary objective is to relieve the load of quotation systems by a quotation mechanism with learning and analysis abilities, to help the manufacturers on strategic analysis, and increase the competitiveness of manufacturers.

The second objective of the invention is to provide customers with dynamic quotations to meet their real-time quotation requirements, and to achieve real-time, interactive and highly efficient quotation processes.

### BRIEF DESCRIPTION OF THE DRAWINGS

FIG. 1 shows the system diagram of the proposed computer network aided quotation analysis system and method.

FIG. 2 shows the diagram of the database update process of the proposed system and method.

FIG. 3 shows the flowchart of the proposed system and method.

FIG. 4-a shows the detailed flowchart of parsing users' quotation requirement of the proposed system and method.

FIG. 4-b shows the detailed flowchart of the quotation result generation of the proposed system and method.

FIG. 4-c shows the detailed flowchart of the generation of data pages of quotation results of the proposed system and method.

### DETAILED DESCRIPTION

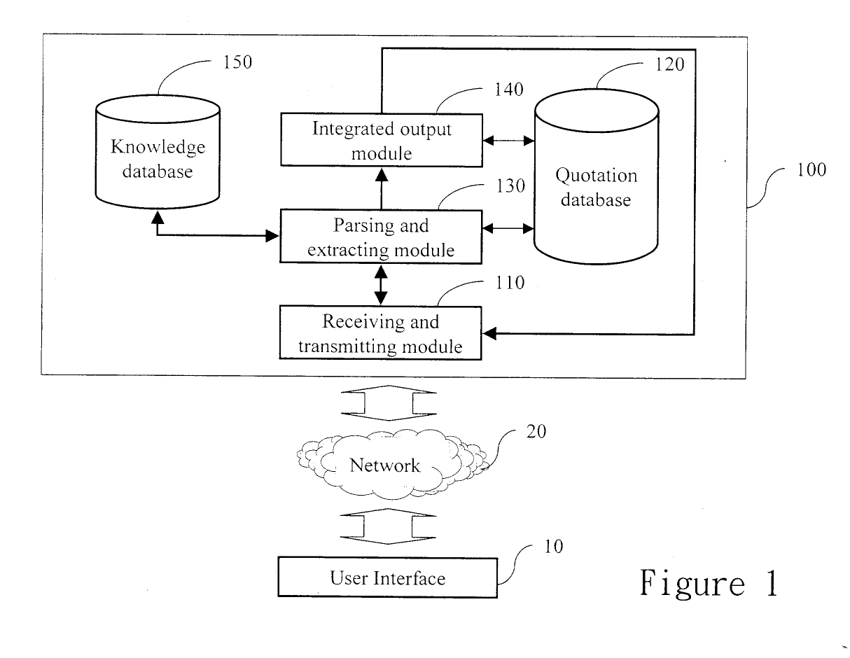

The invention is a computer-network-aided quotation analysis system and method which executes standard and customized quotation processes dynamically, to generate real-time quotation and analytical results according to various quotation requirements put in by the user via networks 20 (including wired and wireless networks). FIG. 1 describes the function blocks of the proposed quotation analysis system 100.

1. A receiving and transmitting module provides user interfaces 10 to receive the quotation requirements of the user (e.g., OEM mode requirements, delivery mode requirements, quotation mode requirements . . . ) and transmits the data pages of the quotation results. User interfaces 10 are executed in users' operation terminals (e.g., desktop PCs, notebook PCs or handheld devices) connecting to the proposed quotation analysis system 100 by wired or wireless networks.

2. A quotation database 120 stores all prices of quotation items (e.g., material quotation, processing quotation, transportation quotation, testing quotation . . . ), quotation rules (e.g., consigned, turnkey, low volume high mix, high volume low mix . . . ), corresponding parameters (e.g., labor rate, testing rate, depreciation rate, tax rate . . . ) and template rules to apply quotation results to different types of user interfaces 10 in operation terminals (e.g., Web page template).

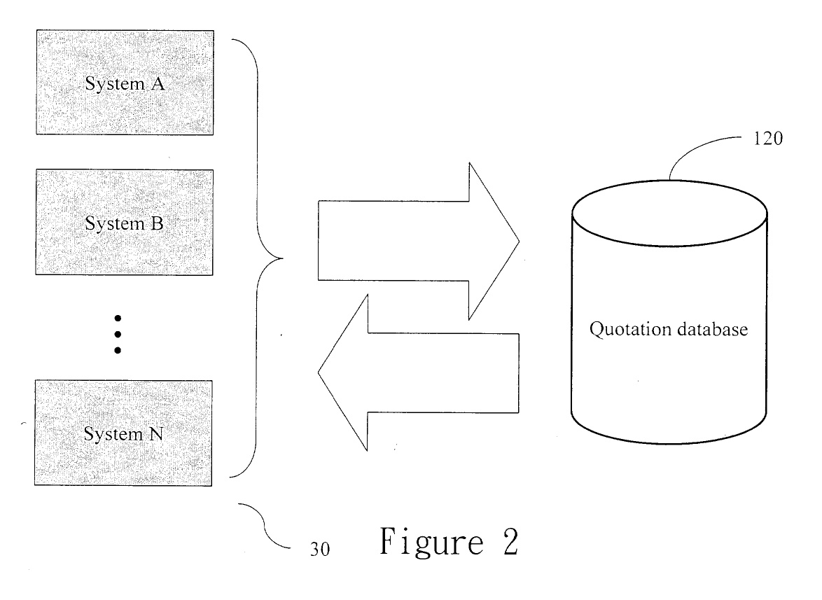

In fact, the stored contents of the quotation database 120 can be updated by external systems 30 (please refer to FIG. 2). For example, quotations of different items can be updated by the quotation systems of third parties and the quotation rules and the corresponding parameters can be updated by the accounting or management systems of third parties. This kind of cooperation between EMS manufacturers and their materials suppliers can increase the flexibility of the proposed system.

3. A parsing and extracting module 130 parsing the quotation requirements put in by the user, and extracts the quotation rules from the quotation database 120 after parsing. Or when the parsing and extracting module finds that the knowledge database 150 contains the quotation results with the same quotation requirements as the ones put in by the user, the parsing and extracting module extracts and returns the quotation results to the knowledge database 150. In addition, the parsing and extracting module 130 analyzes the quotation results to generate various analytical results according to various analysis requirements (e.g., competitiveness analysis, price simulation analysis, profit analysis . . . ). Finally, The parsing and extracting module stores the quotation and analytical results in the knowledge database 150.

4. After determining the types of users' operation terminals, the integrated output module 140 selects the corresponding template rules from the quotation database 120 according to the types of operation terminals, integrates the quotation results, and generates and outputs the data pages of the quotation results according to template rules.

5. A knowledge database 150 stores all quotation and analytical results.

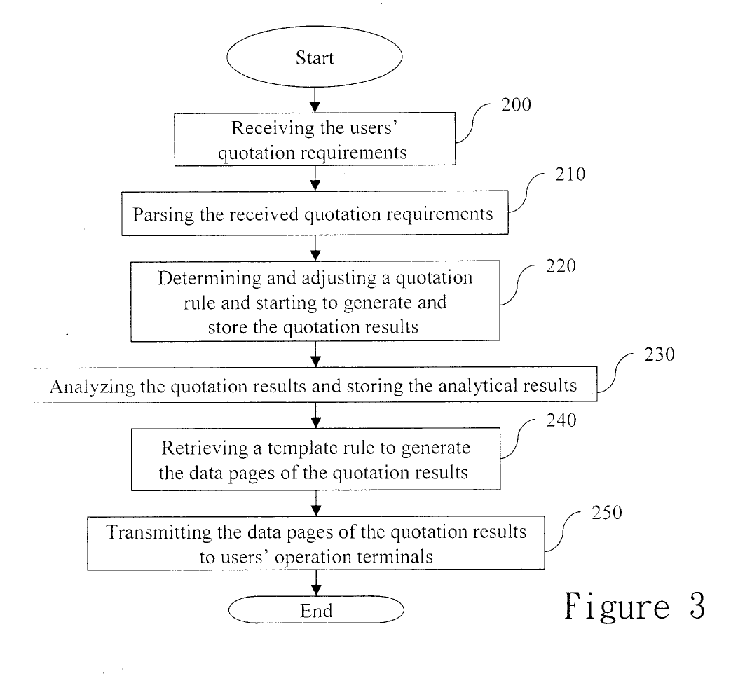

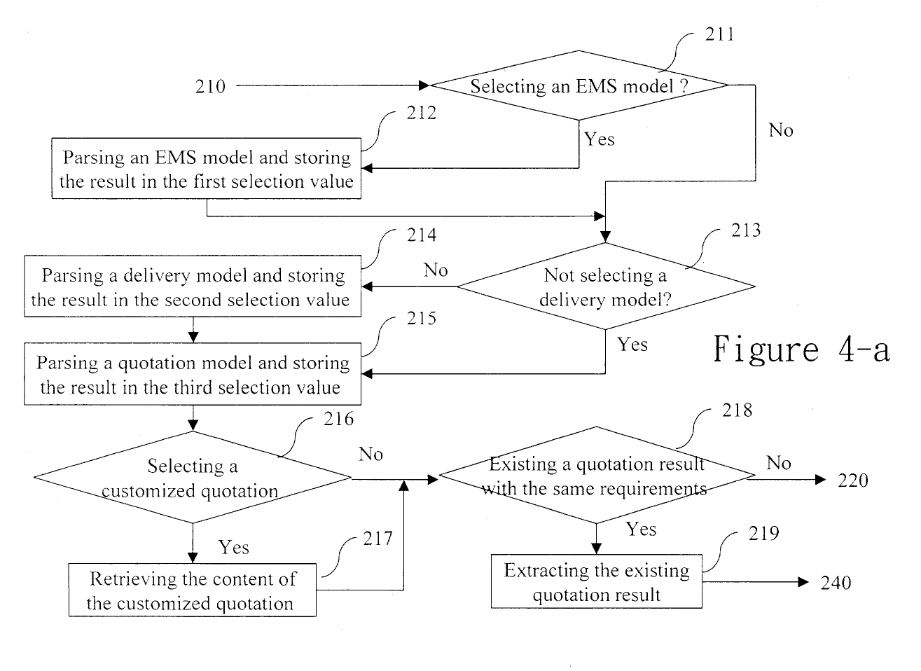

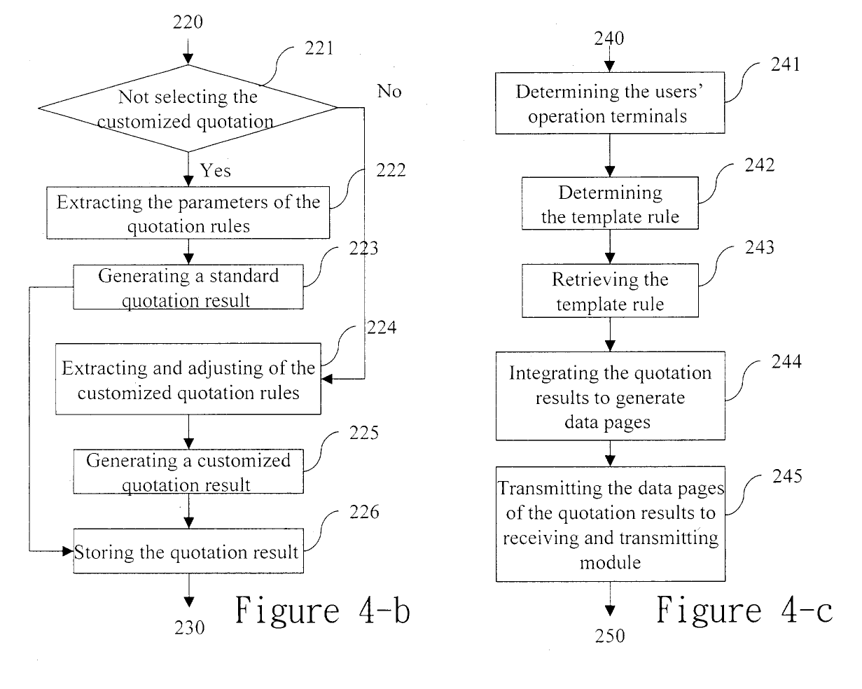

FIG. 3 shows the main flowchart of the invention. First, the receiving and transmitting module receives the quotation requirements put in by the user from user interfaces 10 (Step 200), and the parsing and extracting module 130 parses the quotation requirements (Step 210). Please refer to FIG. 4-a for the detailed flowchart of quotation requirement parsing. Then, the parsing and extracting module selects the corresponding quotation rules according to the parsed results (when users select customized quotation, the parsing and extracting module 130 adjusts quotation rules and corresponding parameters according to the parameters of customized quotation, provided by users), calculates the quotation results, generates quotation results and stores them in the knowledge database 150 (Step 220). Please refer to FIG. 4-b for the detailed flowchart of the quotation result generation. The pursing and extracting module analyzes the quotation results and stores the analytical results (Step 230). Finally, the integrated output module 140 generates the data pages of quotation results (Step 240) based on the template rules according to the types of user' operation terminals and sends the generated data pages to the user' operation terminals to display (Step 250). The flowchart of the generation of the data pages is described in FIG. 4-c.

FIG. 4-a shows the flowchart of the parsing and extracting module 130 parsing the quotation requirements in Step 210. Generally speaking, a quotation requirement received from a user's operation terminal includes the following three parts: an EMS model requirement, a delivery model requirement and a quotation model requirement. The parsing and extracting module first checks if an EMS model is selected by a user (Step 211). If so, the parsing and extracting module parses the content of the EMS model (e.g., consigned, partial turnkey, or full turnkey) and stores the parsing results in the first selection value (Step 212). The module then checks if a delivery model is selected by the user after parsing the OEM model, or if the user does not select an OEM model (Step 213). If so, the module parses the content of the delivery model (e.g., low volume high mix, middle volume middle mix, or high volume low mix) and stores the parsing results in the second selection value (Step 214). The module checks if a quotation model (e.g., standard quotation, or customized quotation . . . ) is selected by the user after parsing the delivery model or if the user does not select a delivery model, and stores the parsing results in the third selection value (Step 215). The module checks if the third selection value is customized quotation (Step 216). If so, the module retrieves the contents of the customized quotation (e.g., delivery due date, delivery location, special material . . . ) (Step 217). If the selected quotation model is standard quotation or the module has retrieved the contents of the customized quotation, the module checks whether there are the same quotation results in the knowledge database according to the first, second and third selection values and the contents of the customized quotation. If so(Step 218), the module extracts existing quotation results from the knowledge database 150 (Step 219), and enters Step 240 in FIG. 4-c to generate data pages of the quotation results. Otherwise, the module enters Step 220 in FIG. 4.b to generate the quotation results.

FIG. 4-b shows the flowchart of the parsing and extracting module 130 to generate the quotation results in Step 220. When the user does not select the customized quotation (Step 221), the module extracts the corresponding quotation rules and parameters from the quotation database 120 based on the first, second and third selection values (Step 222), generates the results of the standard quotation (Step 223), and stores the quotation results (Step 226). On the other hand, when the user selects the customized quotation (Step 221), the module not only extracts the corresponding quotation rules and parameters from the quotation database 120 based on the first, second and third selection values, but also adjusts the corresponding quotation rules and parameters according to the retrieved contents of the customized quotation (Step 224), generates the results of the customized quotation (Step 225), and stores the quotation results (Step 226). When the quotation results (standard and customized quotations) are stored (Step 226), the system enters Step 230 to analyze the quotation results.

FIG. 4-c shows the flowchart of the integrated output module 140 to generate the data pages of the quotation results in Step 240. When the quotation results are generated, the integrated output module 140 first determines the user' operation terminal types (Step 241). The integrated output module 140 automatically determines the corresponding template rules according to the operation terminal types (e.g., desktop PCs, notebook PCs, or handheld devices . . . ) (Step 242). After determining the template rules, the integrated output module extracts the template rules from the quotation database 120 (Step 243), integrates the template rules and the quotation results, and generates the data pages of the quotation results (Step 244). The integrated output module sends the generated data pages to the receiving and transmitting module 110 (Step 245). Then the system enters step 250.

### EFFECTS OF THE INVENTION

The proposed computer-network-aided quotation analysis system and method quotes dynamically according to the user' real-time quotation requirement via network connections, generates standard and customized quotation by built-in quotation rules, and generates up-to-date quotation results according to the latest prices of various items.

With the learning mechanism of the system, when processing massive quotation requirements, the system obtains the quotation results with the same quotation requirement from historical quotation results, hence greatly reduces the system load and improves the efficiency of the quotation processes.

The proposed system analyzes quotation results to generate various analytical reports providing manufacturers with references to enhance quotation processes and increase competitiveness.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments not departing from the spirit and scope of the invention.

What is claimed is:

1. A computer-network-aided quotation analysis system which executes standard and customized quotation processes according to the user-inputted requirements and generates real-time quotation and analytical results, comprising:
a receiving and transmitting module which provides a user interface, receives the user-inputted quotation requirements, and transmits the data pages of the quotation results;
a quotation database which stores the prices of all items, multiple quotation rules, corresponding parameters and template rules;
a knowledge database which stores all historical quotation and analytical results;
a parsing and extracting module which parses the quotation requirements put in by the user, and extracts the quotation rules from the quotation database to process calculation or extracts from the knowledge base the quotation results corresponding to the same quotation requirements, analyzes the quotation results to generate various analytical results, and store the quotation and analytical results in the knowledge base; and
an integrated output module which generates and outputs the data page of the quotation results according to template rules.

2. The system in accordance with claim 1, wherein a user interface is executed in an operation terminal and the said operation terminal connects to the said system via wired or wireless networks to input and select quotation requirements and browser the data pages of the quotation results.

3. The system in accordance with claim 1, wherein a quotation requirement comprises an EMS model requirement, a delivery model requirement and a quotation model requirement.

4. The system in accordance with claim 1, wherein the content of the database of the said system is updated by external systems.

5. The system in accordance with claim 1, wherein the template rules are determined according to the types of operation terminals.

6. A computer-network-aided quotation analysis method which dynamically executes standard and customized quotation according to the user-inputted requirements comprising:
receiving user-inputted quotation requirements;
executing the said requirements;
determining and adjusting the corresponding quotation rules, calculating, generating and storing the quotation results;
analyzing the said quotation results and storing the analytical results;
extracting template rules and generating the data pages of the said quotation results; and transmitting the data pages.

7. The method in accordance with claim 6, wherein a quotation requirement comprises an EMS model requirement, a delivery model requirement, and a quotation model requirement.

8. The method in accordance with claim 6, wherein the steps to parse the said quotation requirement comprise:
parsing the EMS model;
parsing the delivery model;
parsing the quotation model; and
storing the parsed EMS, delivery and quotation models in the first, second and third selection values, respectively.

9. The method in accordance with claim 6, wherein the steps to parse the said quotation requirement comprise reading user-inputted contents of the said quotation requirements when the quotation model is customized quotation.

10. The method in accordance with claim 6, wherein the steps to parse the said quotation requirements comprise extracting the existing quotation results when there exists historical quotation results with the same quotation requirements.

11. The method in accordance with claim 6, wherein the steps to determine and adjust the quotation rules, execute the quotations, generate and store the quotation results comprise:
extracting the corresponding parameters of the said quotation requirement and calculating;
generating standard quotation results; and
storing the quotation results.

12. The method in accordance with claim 6, wherein the steps to determine and adjust the quotation rules, execute the quotations, generate and store the quotation results comprise extracting and adjusting the quotation rules to generate the quotation results of the quotation requirement when the quotation model is customized quotation.

13. The system in accordance with claim 6, wherein the steps to extract the said template rules and generate the data pages of the quotation results comprise:
determining the type of the operation terminal;
determining the template rules;
extracting the said template rules;
integrating the quotation results and generating the data pages of the quotation results; and
transmitting the said data pages.

14. The system in accordance with claim 13, wherein the said template rules are determined according to the types of operation terminals.
